(19) United States
(12) Patent Application Publication
(10) Pub. No.: US 2013/0300612 A1
(43) Pub. Date: Nov. 14, 2013

(54) PATCH ANTENNA WITH THREE RECTANGULAR RINGS

(71) Applicants: Li-Chun Shiue, New Taipei City (TW); Dau-Chyrh Chang, Pan-Chiao City (TW)

(72) Inventors: Li-Chun Shiue, New Taipei City (TW); Dau-Chyrh Chang, Pan-Chiao City (TW)

(73) Assignee: New EA, Inc. dba Flow Mobile, Bismarck, ND (US)

(21) Appl. No.: 13/741,095

(22) Filed: Jan. 14, 2013

Related U.S. Application Data
(60) Provisional application No. 61/585,986, filed on Jan. 12, 2012.

(51) Int. Cl. H01Q 9/04

(52) U.S. Cl. CPC H01Q 9/0407
USPC 343/700 MS

(57) ABSTRACT

The technology disclosed relates to patch antennas and methods of using a patch antenna. In particular, it relates to using a rectangular or square ring radiator and a pair of rectangular ring resonators in a patch antenna. The designs and methods described can, for instance, be applied to communications at about 698 to 746 MHz or 746 to 806 MHz, in a frequency range such as 698-806 MHz.

### RELATED APPLICATIONS

This application is related to and claims the benefit of U.S. Provisional Application No. 61/585,986 filed on Jan. 12, 2012. The related provisional application is hereby incorporated by reference for all purposes.

### BACKGROUND

The technology disclosed relates to patch antennas and methods of using patch antenna. In particular, it relates to using a rectangular or square ring radiator and a pair of rectangular ring resonators in a patch antenna. The designs and methods described can, for instance, be applied to communications at about 698 to 746 MHz or 746 to 806 MHz, in a frequency range such as 698 MHz through 806 MHz.

Dozens of antenna silhouettes have been proposed for patch antennas. Design handbooks sometimes include a page of silhouettes. See, for example, Ramesh Garg, Microstrip Antenna Design Handbook, pages 9, 10, 13, 15, 367 (Artech House 2001).

Historically, antenna design has been a matter of trial and error. Numerical methods such as Finite Difference Time Domain (FDTD) and finite element analysis have provided new tools for approximation of antenna performance, but actual testing and characterization of antennas and assemblies that include antennas remains essential to antenna development.

As new frequency bands are made available for general use and new applications are devised for the frequency bands, opportunities arise for new and improved antenna designs.

### SUMMARY

The technology disclosed relates to patch antennas and methods of using patch antenna. In particular, it relates to using a rectangular or square ring radiator and a pair of rectangular ring resonators in a patch antenna. The designs and methods described can, for instance, be applied to communications at about 698 to 746 MHz or 746 to 806 MHz, in a frequency range such as 698 MHz through 806 MHz. Higher frequencies generally allow smaller dimensions to be used for the radiator and resonators.

Other aspects and advantages of the technology disclosed can be seen on review of the drawings, the detailed description and the claims, which follow.

### BRIEF DESCRIPTION OF THE DRAWINGS

FIG. 1 is a first antenna design with dimensions.

FIG. 2 is a second antenna design with dimensions.

FIG. 3 is a line drawing of an example device incorporating one of the antenna designs.

FIG. 4A through 4G depict simulated performance characteristics of the first antenna design.

FIG. 5A through 5F depict measured performance characteristics of the first antenna design.

FIG. 6A through 6G depict simulated performance characteristics of the second antenna design.

FIG. 7A through 7B depict measured performance characteristics of the second antenna design.

### DETAILED DESCRIPTION

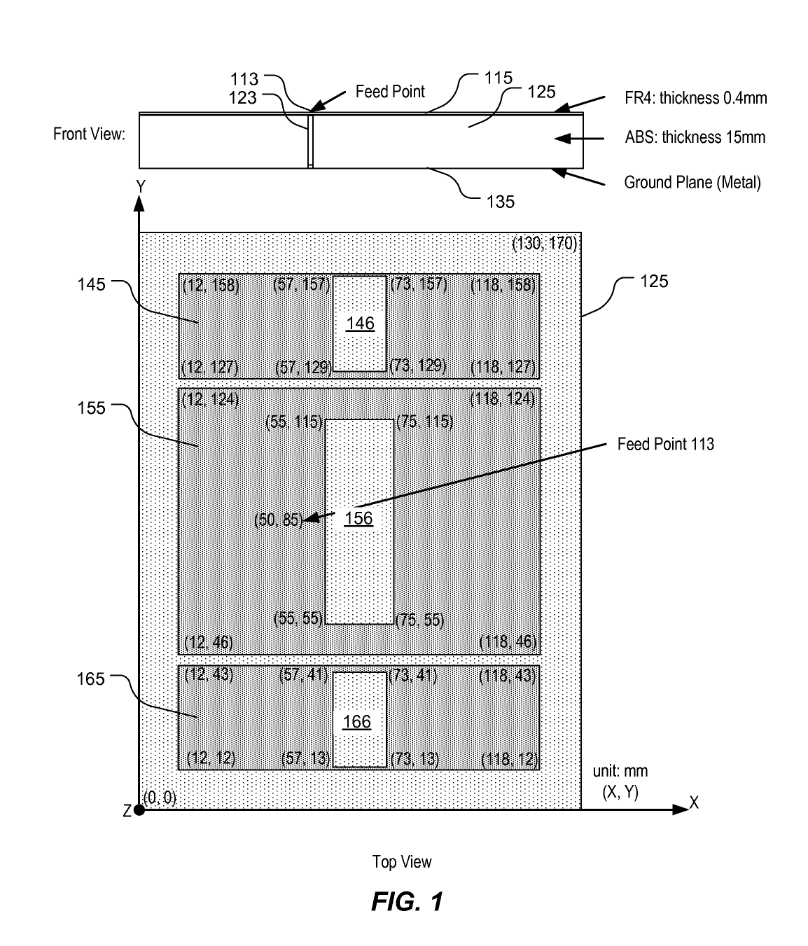

A detailed description of implementations of the technology disclosed is provided with reference to the FIG. 1 through 7.

FIG. 1 is a first antenna design with coordinates in parentheses. Dimensions in mm can be found based on the coordinates.

FIG. 1 shows a rectangular ring radiator 155 with two coplanar rectangular ring resonators 145, 165 on opposing sides that overlie a printed circuit board 115 which overlies a dielectric substrate 125. A metallic ground plane 135 underlies the dielectric substrate 125.

In one implementation, the radiator 155 and the resonators 145, 165 include a conductive metallic layer on the surface of a 0.4 mm thick printed circuit board 115 comprised of a suitable material such as FR-4, FR-5, CEM-3 or G-11. A range of thicknesses can be used for the FR-4 or other suitable material, such as 0.3 mm to 0.6 mm. More broadly, the printed circuit board layer of FR-4 can be 0.2 mm to 1.0 mm thick. Copper, including copper foil, copper tape and copper printing, can be used for the rectangular rings. Other suitable materials include aluminum. In an alternate embodiment the conductive metallic layer may be placed directly on the dielectric substrate instead of a PCB.

In this description and the following, ranges of dimensions and alternative configurations and materials are given. Not all components dimensions can be effectively used with all other dimensions, configurations and materials. With the instructions given herein, alternative designs can readily be constructed, simulated and tested for performance, all of which share use of three ring patches and a solid dielectric underlying the patches. More expensive dielectric materials can be used to produce an antenna with a lower profile, narrower along the X-axis in FIG. 1.

The dielectric substrate 125 includes a layer of acrylonitrile butadiene styrene (abbreviated ABS) 15 mm thick, which underlies the radiator 155 and the resonators 145, 165 and extends 12 mm beyond the outer edges of the radiator and resonators on all sides. Some alternate low cost materials for the dielectric substrate include plastic, polypropylene, polyethylene, polyamide, Plexiglas (poly methyl methacrylate) or vinyl. Other suitable materials include ceramic, RT/Duroid or glass. For one type of ABS, the dielectric constant is 2.3. Low cost materials with a dielectric constant that falls in the range of 2.3 to 2.7 can be used. More broadly, material with a dielectric in the range of 2.0 to 3.5 can be used. A range of thicknesses can be used for the dielectric, such as 10 mm to 17 mm. More broadly, the dielectric layer can be 5 mm thick and up to 18 mm thick for those with a lower dielectric constant. A thinner dielectric layer in a range of 4 mm to 10 mm can be used with a material having a higher dielectric constant, from 3.5 to 20. A range of border extensions from 12 mm to 15 mm can be used. More broadly, the border extension can be 10 mm to 36 mm wide.

The two resonators 145, 165 are coupled through gaps to the radiator 155. The radiator is fed at a point 113 using a coaxial cable with the inner conductor 123 connected to the radiator and the outer conductor connected to the ground plane 135.

The combination of three ring shaped antenna components, radiator and resonators as described above, permits a design in which the dimension of the radiator along the X-axis in FIG. 1 is less than 0.9 of the half wavelength of a center frequency in the range of 698 MHz to 806 MHz, while maintaining greater than 3 dB gain at a bandwidth of +/−20 MHz from the center frequency.

The metallic ground plane 135 may be tin or other conductive material such as copper or any metal. Low cost conductive materials can be used.

As shown in the diagram, the radiator 155 is 106 mm wide along the X-axis and 78 mm tall along the Y-axis. A rectangular cutout 156 of dimensions 20 mm wide by 60 mm tall is centered in the radiator 155. The aspect ratio of the radiator 155 depicted is 1.36:1. In some implementations, the radiator can be 103 mm to 116 mm wide. More generally, it can be 98 mm to 126 mm wide. The radiator can be 74 mm to 82 mm tall. More generally, it can be 70 mm to 90 mm tall. The aspect ratio of the radiator 155 can be in the range of 1.33:1 to 1.39:1. More generally, it can be in the range of 1.30:1 to 1.42:1. The cutout in the radiator can be 18 mm to 22 mm wide. More generally, it can be 15 mm to 25 mm wide. The radiator cutout can be 57 mm to 63 mm tall. More generally, it can be 54 mm to 66 mm tall. The aspect ratio of the cutout can be in the range of 2.8:1 to 3.2:1. More generally, it can be in the range of 2.5:1 to 3.5:1. Variations on a rectangular shaped cutout include modifying the corners to be rounded, chamfered or otherwise modified while maintaining the basic rectangular shape.

A first resonator 145 having dimensions 106 mm wide by 31 mm long is positioned coplanar, parallel to and centered with the radiator 155. The aspect ratio of the resonator depicted is 3.42:1. The resonator 145 is separated from the radiator 155 by a 3 mm gap. A cutout 146 having dimensions 16 mm wide by 28 mm long is centered along the width of the first resonator 145 but is offset vertically such that it is 1 mm from the outer edge of the first resonator 145 at the top of the Fig. and 2 mm from the inner edge facing the radiator 155. The resonator can be 52 mm to 58 mm tall. More generally, it can be 50 mm to 60 mm tall. The aspect ratio of the resonator can be in the range of 3.38:1 to 3.46:1. More generally, it can be in the range of 3.35:1 to 3.50:1.

A second resonator 165 having the same dimensions as the first resonator is similarly positioned coplanar, parallel and centered with the radiator 155 on the opposing side of the radiator 155. The second resonator 165 is separated from the radiator 155 by a 3 mm gap. A cutout 166 in the second resonator and having the same dimensions as the cutout 146 in the first resonator 145 is centered along the longer side of the radiator 155 as shown and offset so as to be 1 mm from the outer edge of the second resonator and 2 mm from its inner edge.

A feed point 113 is 5 mm from the edge of the radiator cutout 156 and centered along a longer side of the radiator cutout. With this feed point, the first antenna design is linearly polarized. The antennas disclosed in this application have polarization compatible with the base stations with which they communicate.

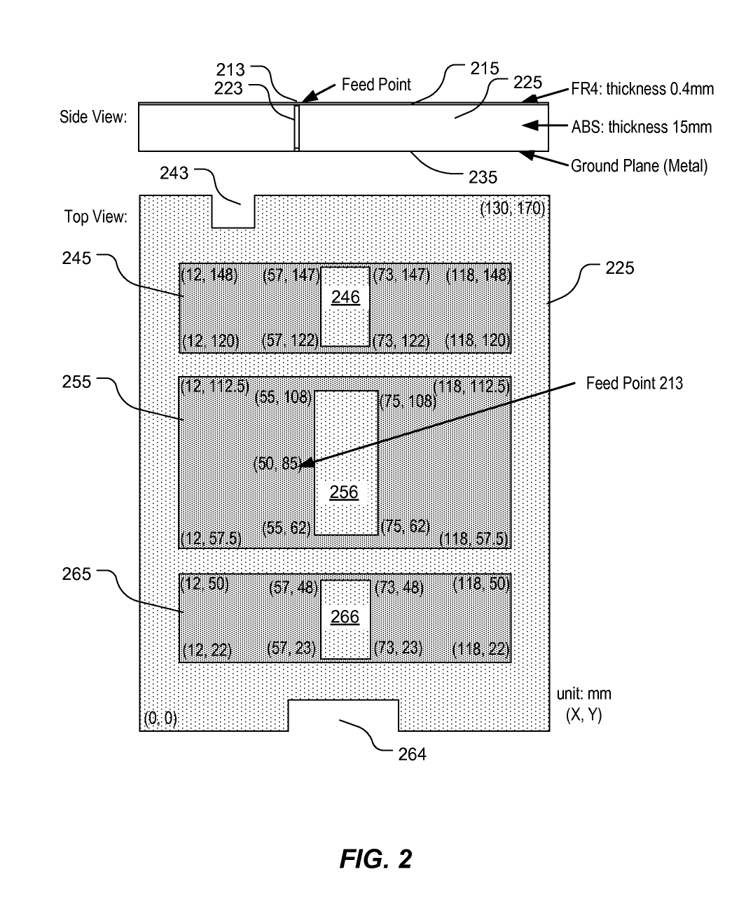

FIG. 2 is a second antenna design similar to the first antenna design shown in FIG. 1. FIG. 2 shows a rectangular ring radiator 255 with two coplanar rectangular ring resonators 245, 265 on opposing sides that overlie a printed circuit board 215 constructed of FR-4 or similar material which overlies a dielectric substrate 225. A metallic ground plane 235 underlies the dielectric substrate 225. The two resonators 245, 265 are coupled through gaps to the radiator 255. The radiator is fed at a point 213 using a coaxial cable with the inner conductor 223 connected to the radiator and the outer conductor connected to the ground plane 235.

The radiator 255 includes a cutout 256 similar to the cutout 156 in FIG. 1, and the resonators 245,265 contain cutouts 246, 266 similar to the cutouts 146, 166 in FIG. 1. The dimensions and characteristics of the printed circuit board 215, the dielectric substrate and the ground plane 235 are the same as those for the antenna design shown in FIG. 1 except for the notches 243, 264 which allow space to accommodate various connectors. The dimensions of the radiator 255, the resonators 245, 265 and their respective cutouts 256, 246, 266 are different as they are designed to perform better in the upper half of the 698 MHz to 806 MHz frequency range.

As shown in the diagram, the radiator 255 is 106 mm wide along the X-axis and 55 mm tall along the Y-axis. A rectangular cutout 256 of dimensions 20 mm wide by 46 mm long is centered in the radiator 255. The aspect ratio of the radiator depicted is 1.93:1. The radiator can be 103 mm to 116 mm wide. More generally, it can be 98 mm to 126 mm wide. The radiator can be 52 mm to 58 mm tall. More generally, it can be 50 mm to 60 mm tall. The aspect ratio of the radiator can be in the range of 1.90:1 to 1.96:1. More generally, it can be in the range of 1.88:1 to 2.0:1. The cutout in the radiator can be 18 mm to 22 mm wide. More generally, it can be 15 mm to 25 mm wide. The radiator cutout can be 43 mm to 49 mm tall. More generally, it can be 40 mm to 52 mm tall. The aspect ratio can be in the range of 2.1:1 to 2.5:1. More generally, it can be in the range of 1.8:1 to 2.8:1. Variations on a rectangular shaped cutout include modifying the corners to be rounded, chamfered or otherwise modified while maintaining the basic rectangular shape.

A first resonator 245 having dimensions 106 mm wide by 28 mm long is positioned coplanar, parallel to and centered with the radiator 255. This resonator 245 is separated from the radiator 255 by a 7.5 mm gap. The aspect ratio of the resonator depicted is 3.79:1. A cutout 246 having dimensions 16 mm wide by 25 mm long is centered along the width of the first resonator 245 but is offset vertically such that it is 1 mm from the outer edge of the first resonator 245 at the top of the Fig. and 2 mm from the inner edge facing the radiator 255. The resonator can be 103 mm to 116 mm wide. More generally, it can be 98 mm to 126 mm wide. The resonator can be 52 mm to 58 mm tall. More generally, it can be 50 mm to 60 mm tall. The aspect ratio of the resonator can be in the range of 3.75:1 to 3.83:1. More generally, it can be in the range of 3.70:1 to 3.87:1.

A second resonator 265 having the same dimensions as the first resonator is similarly positioned coplanar, parallel and centered with the radiator 255 on the opposing side of the radiator 255. The second resonator 265 is separated from the radiator 255 by a 7.5 mm gap. A cutout 266 in the second resonator and having the same dimensions as the cutout 246 in the first resonator 145 is centered along the width of the radiator 255 and offset so as to be 1 mm from the outer edge of the second resonator and 2 mm from its inner edge.

A feed point 213 is 5 mm from the edge of the radiator cutout 256 and centered along a longer side of the radiator cutout.

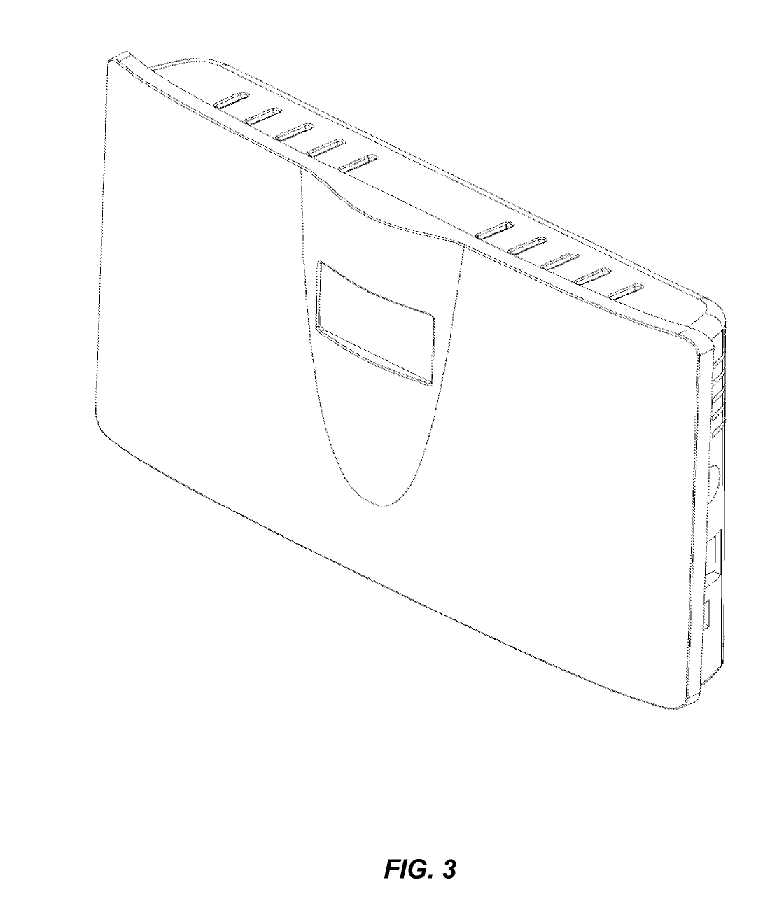

FIG. 3 is a line drawing of an example of a device incorporating one of the antenna designs. This example device can sit on a table top, preferably at a window where it can be directed toward a base station.

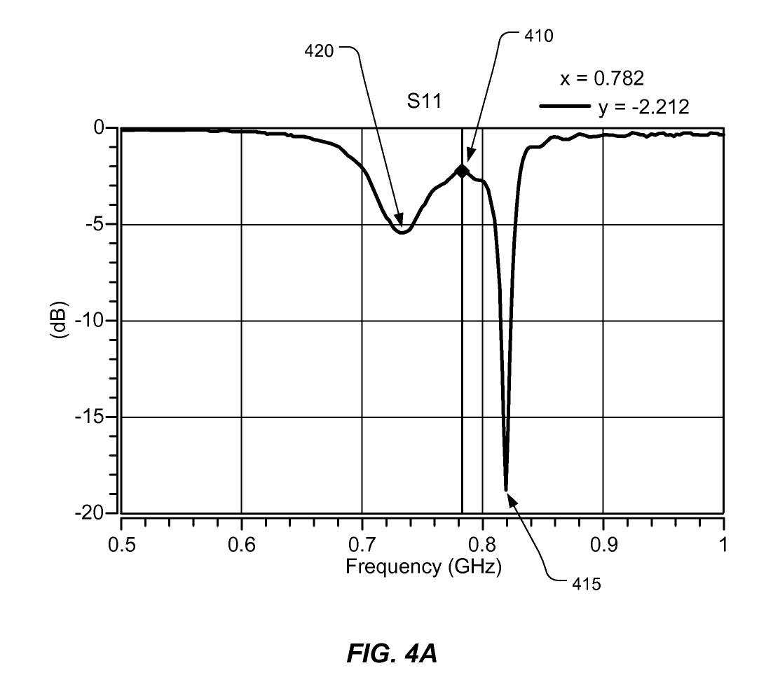

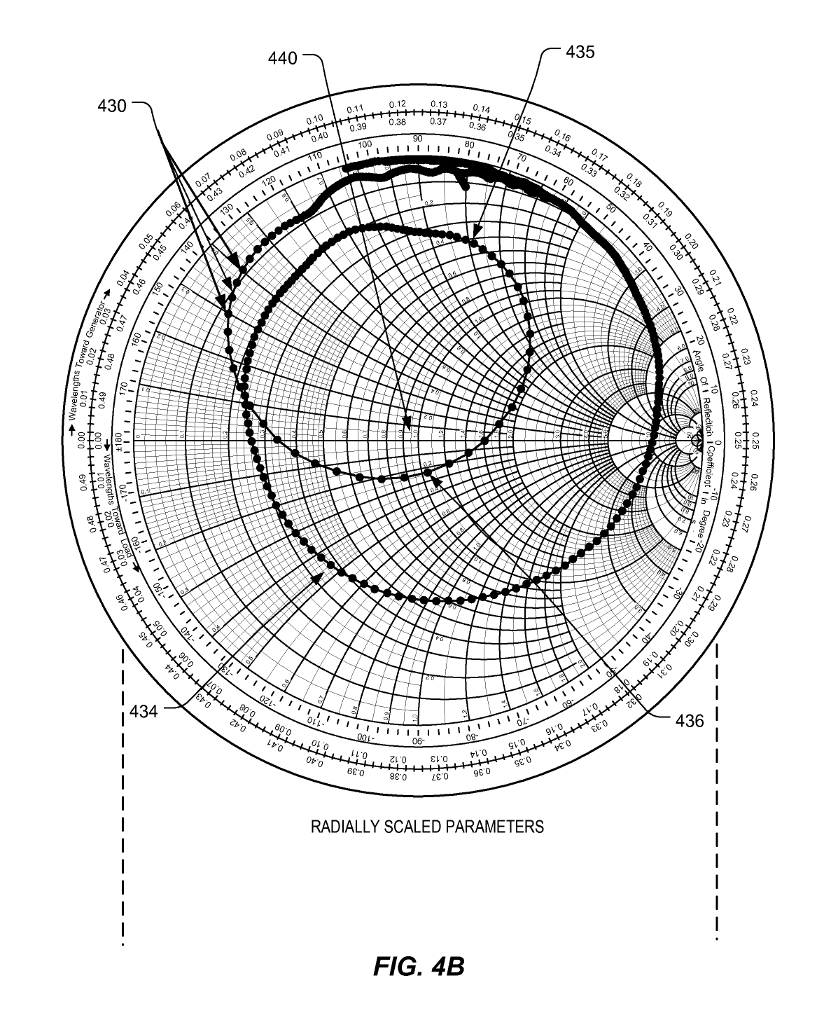

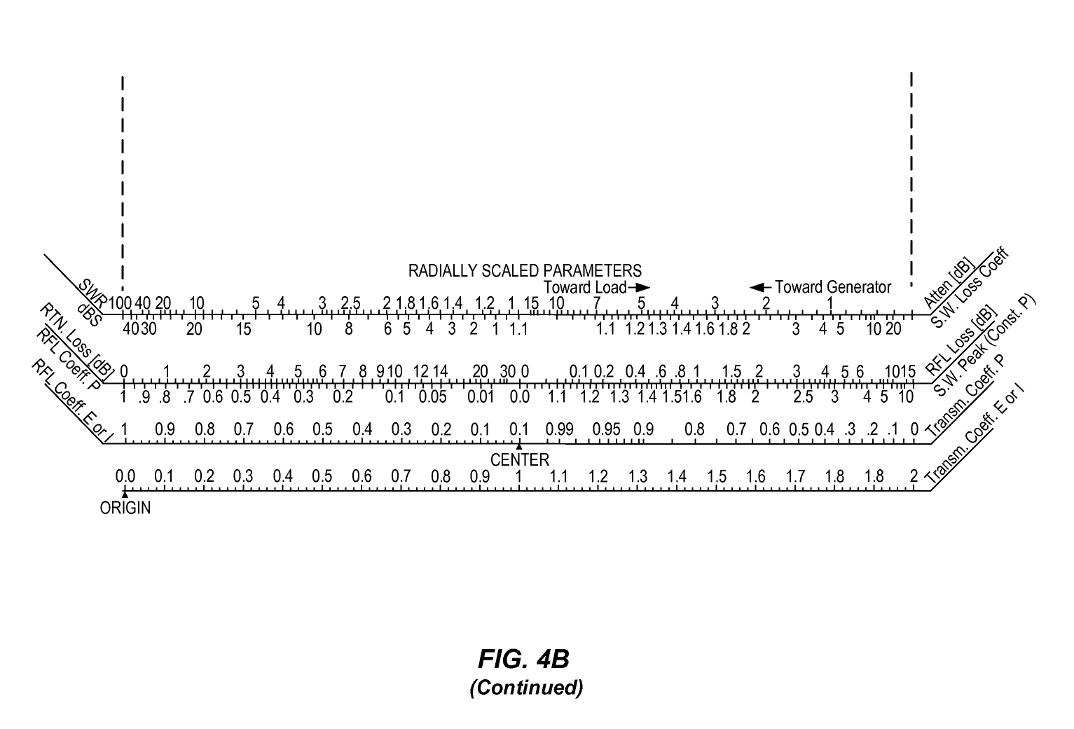

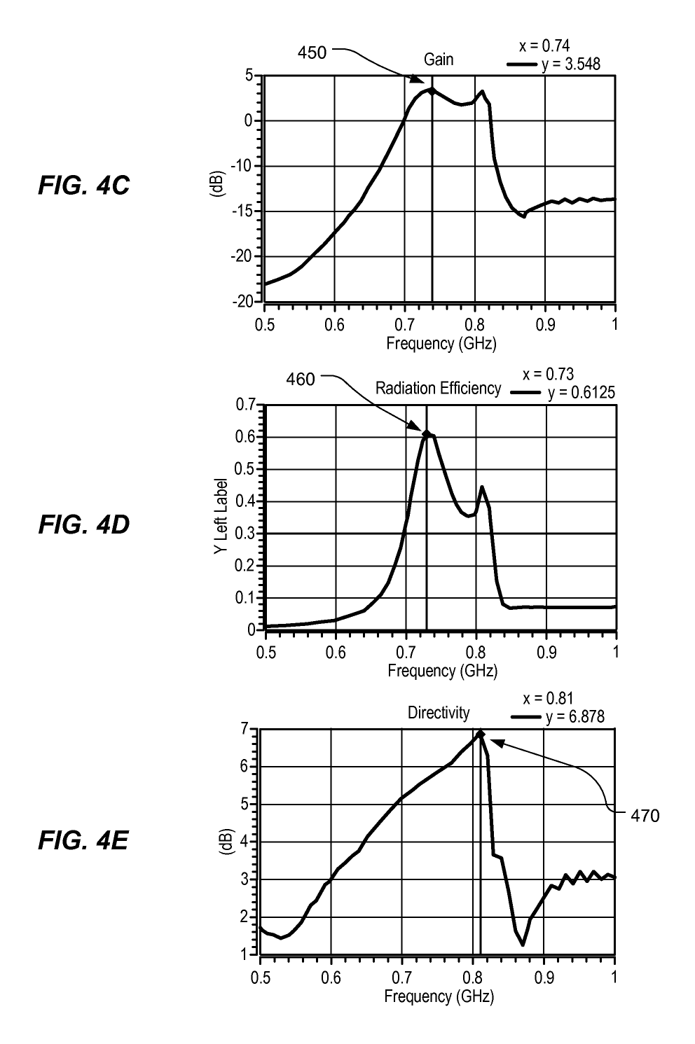

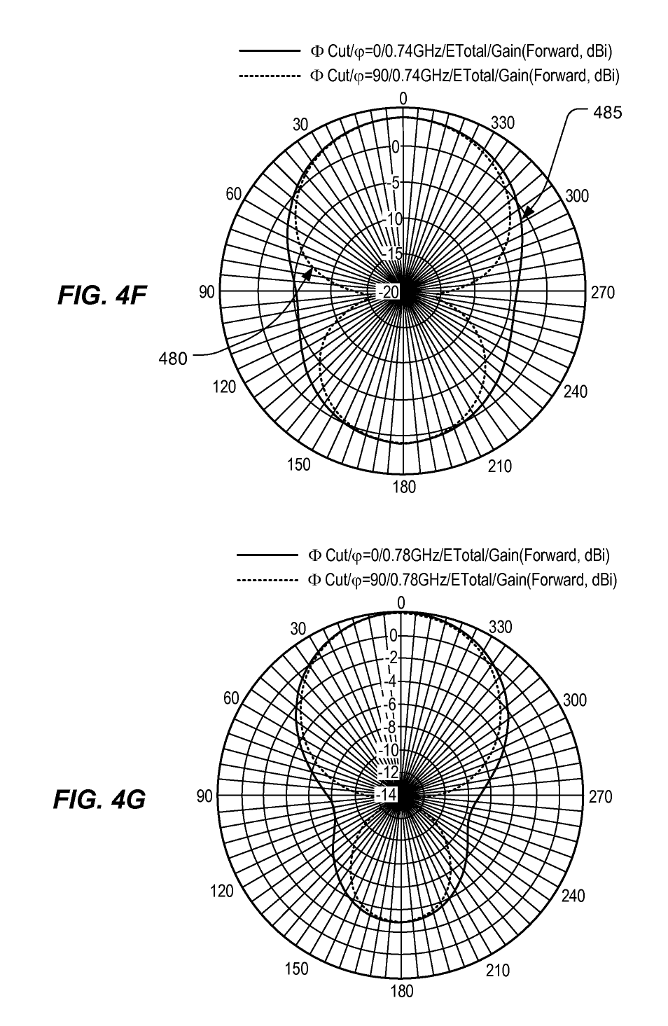

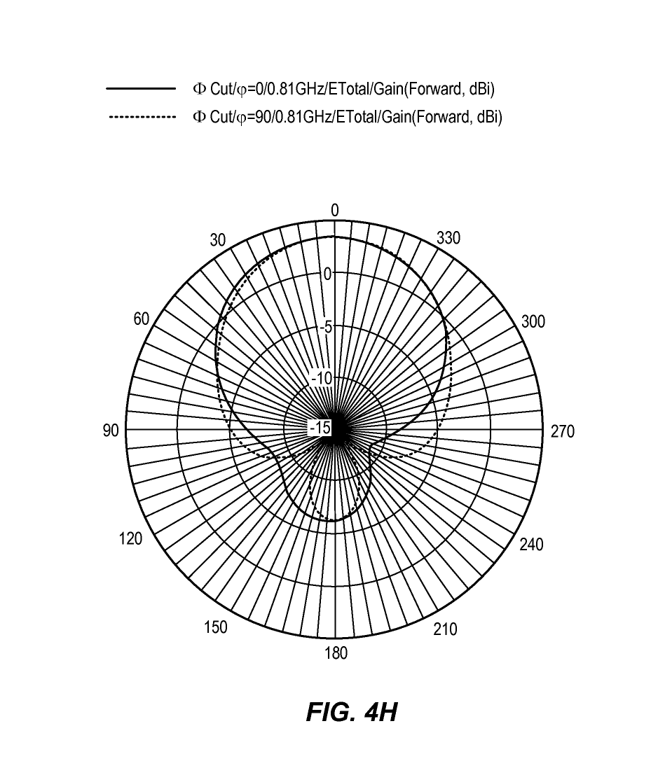

FIG. 4A through 4G depict simulated performance characteristics of the first antenna design.

FIG. 4A is a plot of the simulated return loss, also called the reflection coefficient, of the first antenna design antenna without the radome and PCBA (printed circuit board assembly) over a range of frequencies. This represents how much power is reflected from the antenna back to the power source. At 0 dB all of the power is reflected and none is radiated. According to the plot in FIG. 4A, at point 410 the frequency is 782 MHz the return loss is −2.212 dB. At point 420 the frequency is 732 MHz and the return loss is −5.5 dB. The radiator 155 in FIG. 1 is particularly effective around this frequency. At point 415 the frequency is 819 MHz and the return loss is −19 dB which is substantially better owing to the presence of the resonator cutouts 146 and 166 shown in FIG. 1, i.e. less power is reflected, however as can be seen from the chart, the bandwidth for this improved return loss is very narrow. For the frequency band from 0.7 to 0.8 GHz the return loss varies from −2 dB to −5.5 dB.

FIG. 4B is a Smith Chart of the simulated reflection coefficients for the first antenna without the radome and PCBA over a range of frequencies from 0.5 GHz to 1.0 GHz. The center of the chart at the point 440 labeled “1.0” represents a perfect impedance match between the first antenna design and a power source. At this point, all of the power from a power source connected to the antenna would be absorbed by the antenna. Several dots 430 are placed along a circular line that has an inner loop 435 with each dot corresponding to a frequency at which the simulation was performed. The dot at the point labeled 434 is 732 MHz and corresponds to the frequency at point 420 in FIG. 4A, and the dot at the point labeled 436 is 819 MHz and corresponds to the frequency at point 415 in FIG. 4A. The distance from a dot to the center of the chart 440 is the value of its reflection coefficient. Hence, dots closer to the center of the chart have a lower reflection coefficient that, in turn, corresponds to a better impedance match between the first antenna and a power source at the corresponding frequency. Thus, those dots on the inner loop 435 on the chart represent a range of frequencies at which the first antenna best matches the impedance at the feed point 113.

FIG. 4C is a chart of the simulated gain for the first antenna design without the radome and PCBA. The maximum gain of 3.548 dB occurs at point 450 at a frequency of 740 MHz. The radiator 155 in FIG. 1 is particularly effective around this frequency. The gain at 810 MHz is 3.5 dB due to the design of the resonator cutouts 146, 166 in FIG. 1. For the frequency range 0.7 GHz to 0.8 GHz the gain is 2 dB or greater.

FIG. 4D is a chart of the simulated radiation efficiency of the first antenna design without the radome and PCBA. Radiation efficiency is ratio of the total power radiated by an antenna to the net power accepted by the antenna from a connected transmitter. A radiation efficiency of 1.0 is perfect, indicating that all of the power accepted by the antenna is radiated by the antenna. Conversely, a radiation efficiency of 0.0 would indicate that none of the accepted power would be radiated. For the first antenna design, the simulated maximum radiation efficiency of 0.6125 occurs at point 460 at a frequency of 730 MHz. The radiator 155 in FIG. 1 is particularly effective around this frequency. The small peak measuring 0.44 at 810 MHz is due to the design of the resonator cutouts 146, 166 in FIG. 1. For the frequency range 0.7 GHz to 0.8 GHz, the radiation efficiency is above 0.35.

FIG. 4E is a chart of the simulated directivity of the first antenna design without the radome and PCBA. Directivity is a measure of how well an antenna radiates in a given direction with respect to a perfect antenna, called an isotropic antenna, which radiates equally well in all directions. Such a perfect antenna, not achievable in practice, would have zero directionality and a corresponding value of 0 dB. For the first antenna design, the simulated maximum directivity of 6.878 dB occurs at point 470 at a frequency of 810 MHz. For the frequency range 0.7 GHz to 0.8 GHz, the directivity is above 5 dB.

FIGS. 4F, 4G and 4H are three charts of the simulated radiation patterns of the first antenna design without the radome and PCBA at three different frequencies. Radiation patterns are visualized in spherical coordinates in which a Z axis is vertical and orthogonal to an X axis which is in turn orthogonal to a Y axis. The Z axis is orthogonal to the X-Y plane formed by the X and Y axes. In physics and by convention antenna design, spherical coordinates are designated by three values: a radius (distance from the center of an imaginary sphere), a polar angle called theta which is referenced to the Z axis which has a polar angle of 0, and an azimuth angle called phi which is referenced to the X axis which has an azimuth of 0. Each chart is a 2 dimensional representation of a slice, also called a cut, of a 3 dimensional radiation pattern taken at two different polar angles (theta=0 degrees and theta=90 degrees). In FIG. 4F a first closed line 480 having two circular lobes is shown with the larger lobe facing 0 degrees. This line shows the radiation pattern from a fixed polar angle of 90 degrees and may be visualized as if viewed looking down on the antenna such that the antenna is oriented on edge with the Z axis (per the spherical coordinate system described above) parallel to the longer side of the radiator 155 and vertically bisecting the radiator 155 shown in FIG. 1. Looking at the larger of the two lobes, called the forward or major lobe, it can be seen that this lobe exhibits a maximum gain which exceeds 0 dBi (dBi are decibels with respect to an ideal isotropic antenna).

In FIG. 4F, a second closed line 485 having no distinct lobes appears on this chart and shows the radiation pattern as viewed from a fixed polar angle of 0 degrees and may be visualized as if looking at the antenna orthogonal to the Z axis. In this case the larger end of the pattern shows that the first antenna design radiates more towards the top of the antenna in this simulation.

FIGS. 4G and 4H show the same information as described in FIG. 4F which is simulated at 740 MHz, with the only change being that the plot in FIG. 4G is simulated at 780 MHz and the plot in 4H is simulated at 810 MHz. It is apparent from these three charts (FIGS. 4F, 4G and 4H) that the simulated radiation pattern for the first antenna design is broader at 740 MHz than 810 MHz with the radiation pattern for 780 MHz falling in between.

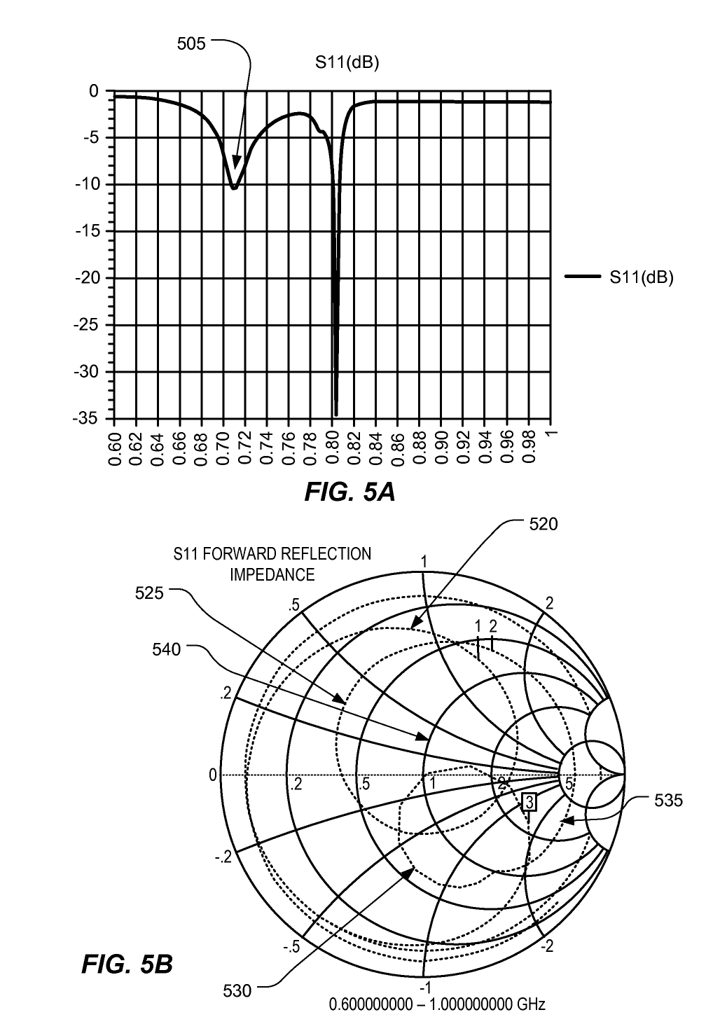

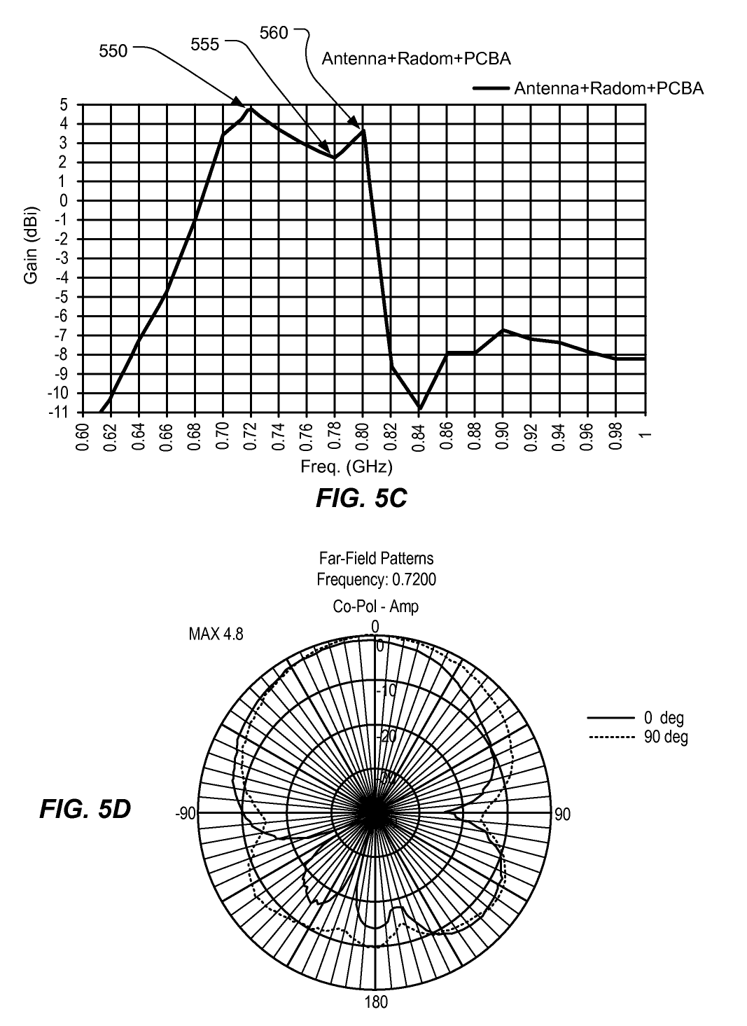

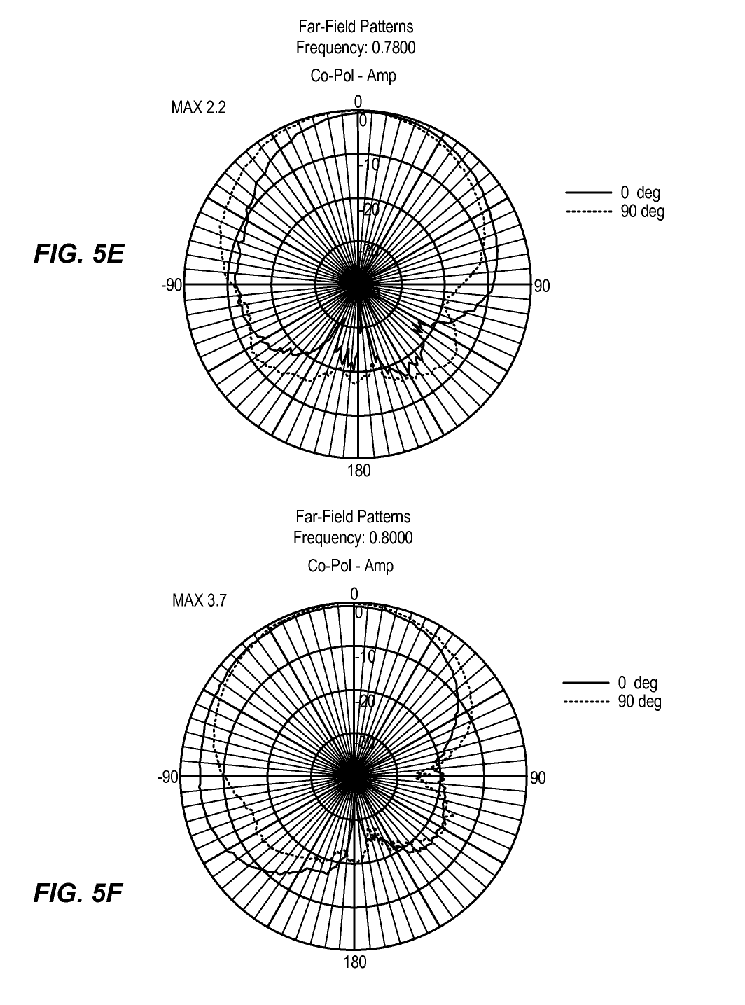

FIG. 5A through 5F depict measured performance characteristics of the first antenna design.

FIG. 5A is a plot of the measured return loss for the first antenna design including the radome and the PCBA over a range of frequencies. At point 505 the frequency is 0.71 GHz and the measured return loss is −10.5 dB compared to the analogous result of −5.5 dB at point 420 in the simulation of FIG. 4A. The 5 dB difference is due to the absorption of reflected power by the connectors and adaptors present in the physical measurement setup. This difference does not represent an improvement in the return loss. The return loss at 0.805 GHz, which as can be seen from the chart is applicable only to a relatively narrow bandwidth, is measured at −34.5 dB versus −19 dB at point 415 in FIG. 4A. However, this difference is again due to the absorption of reflected power by the connectors and adaptors present in the physical measurement setup. This difference does not represent an improvement in the return loss. For the frequency band from 0.7 GHz to 0.8 GHz the return loss is consistent with the simulated return loss calculation after compensating for the presence of adapters and connectors.

FIG. 5B is a Smith Chart, analogous to FIG. 4B, of the measured reflection coefficients for the first antenna, including the radome and the PCBA, over the frequency range from 0.6 GHz to 1.0 GHz. The center of the chart at the point 540 labeled “1” represents a perfect impedance match between the first antenna design and a power source. A dotted line 520 having a large inner loop 525 connected to and overlapping a small inner loop 530 appears on the chart. Taken together the area outlined by these two loops 525, 530 and the line 535 which connects them is more centered in the chart and indicates a more uniform impedance match for the range of measured frequencies which it represents than does the analogous inner loop 435 in FIG. 4B.

FIG. 5C, analogous to the simulation of FIG. 4C, is a chart of the measured gain for the first antenna design however it includes the radome and the PCBA. The maximum gain of 4.8 dBi occurs at point 550 at a frequency of 720 MHz, somewhat better than the 3.548 dB simulated value which occurs at point 450 in FIG. 4C. For the frequency range 0.7 GHz to 0.8 GHz the gain is greater than 2 dBi which exceeds the corresponding simulated gain shown in FIG. 4C.

FIGS. 5D, 5E and 5F are measured radiation patterns which include the antenna, radome and PBA and correspond to the simulated radiation patterns in FIGS. 4F, 4G and 4H respectively. The frequencies however are different being 720 MHz in FIG. 5D, 780 MHz in FIG. 5E and 800 MHz in FIG. 5F. The measured radiation patterns in all cases for FIGS. 5D, 5E and 5F are broader and less symmetrical than the simulated patterns in FIGS. 4F, 4G and 4H, because the simulation was performed without the radome and PCBA, and the measurement included the radome and PCBA. The PCBA includes an F-type adaptor and RJ45 adaptor, both of which affect the antenna performance. The measured maximum gain values of 4.8 dBi at 720 MHz in FIG. 5D, 2.2 dBi at 780 MHz in FIG. 5E and 3.7 dBi in FIG. 5F are taken from the measurements shown in FIG. 5C at points 550, 555 and 560 respectively.

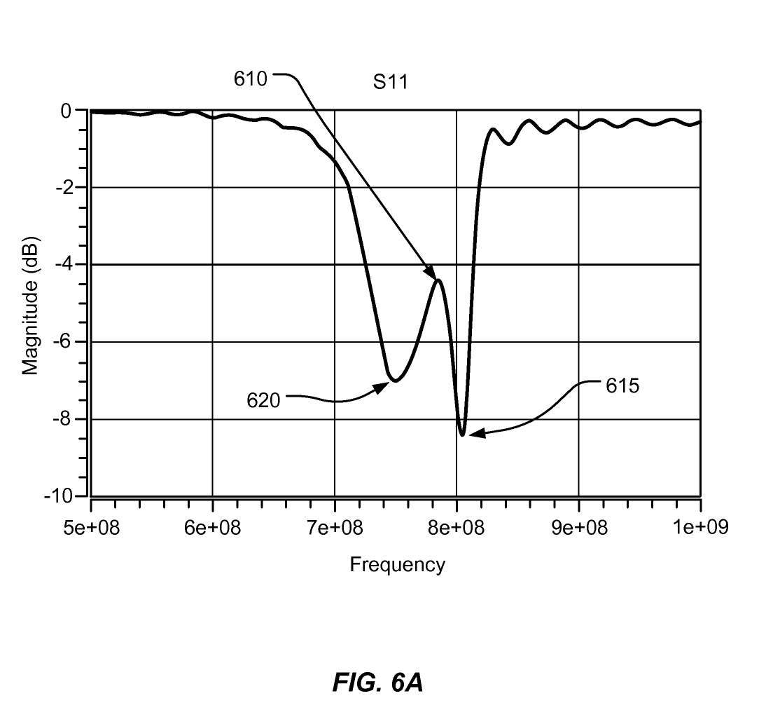

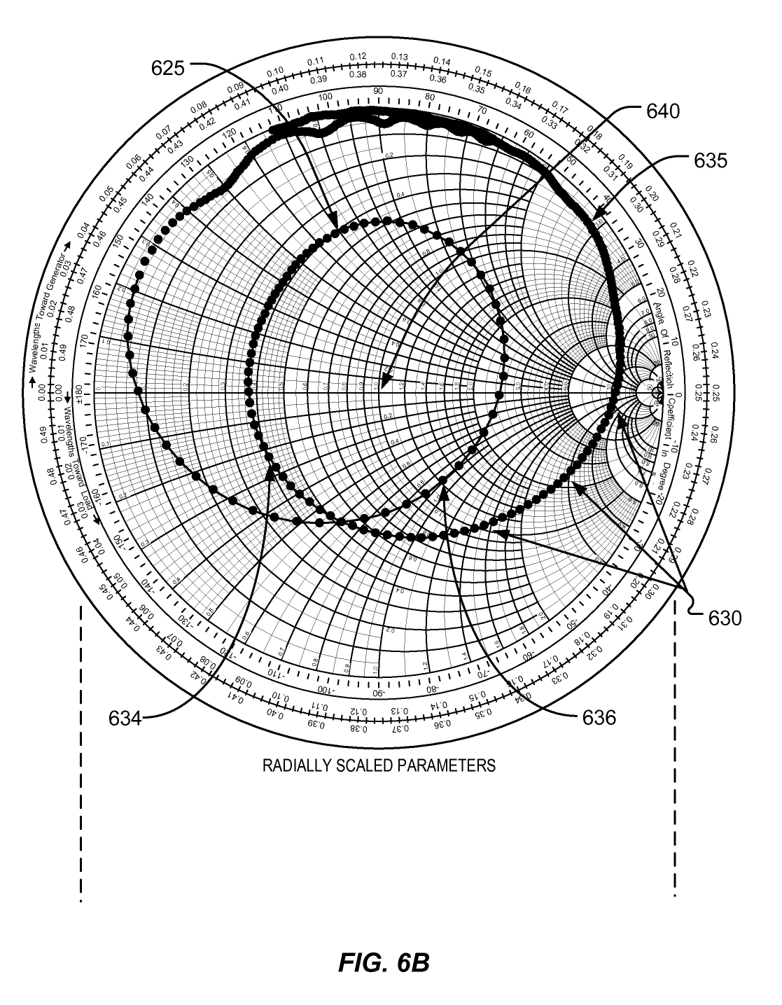

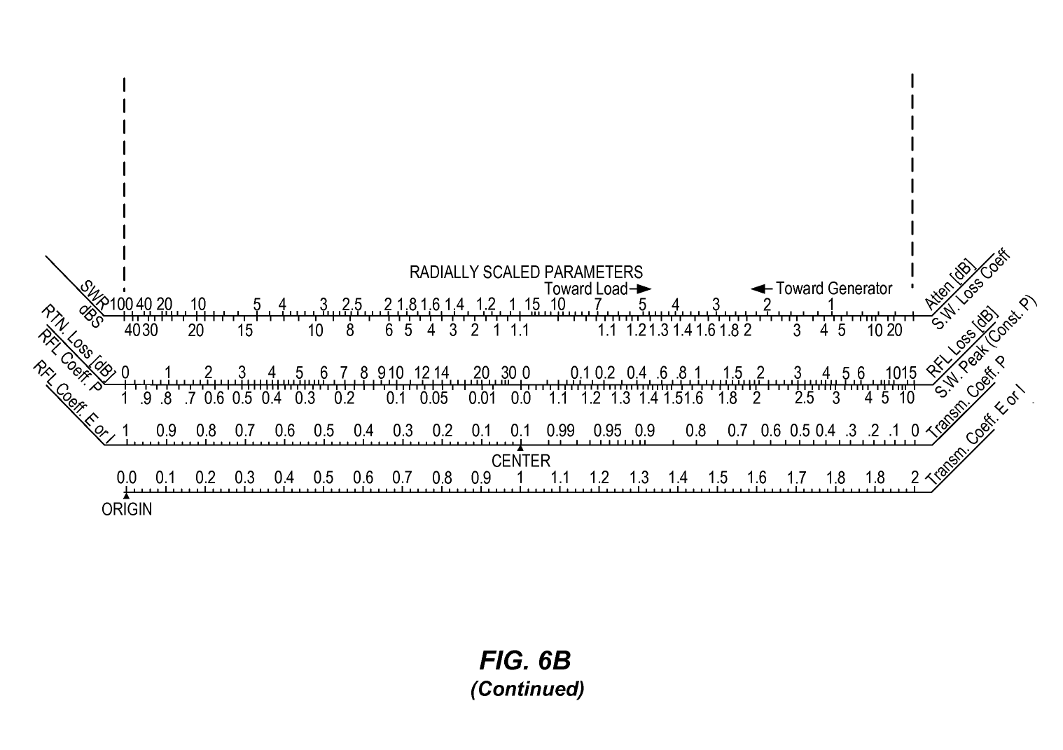

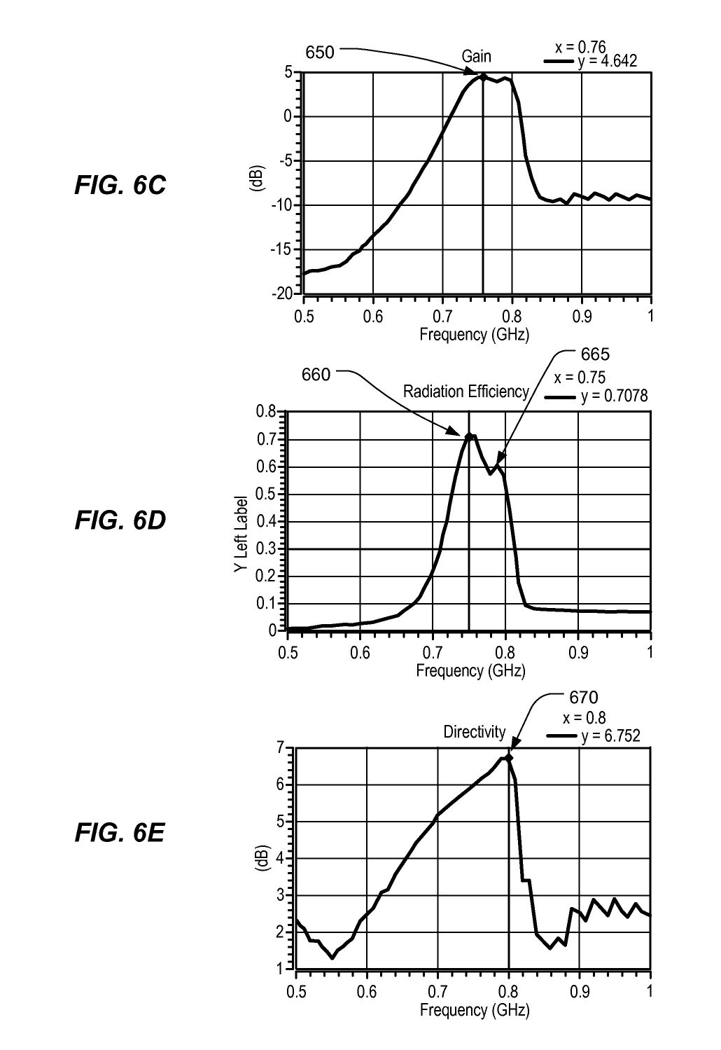

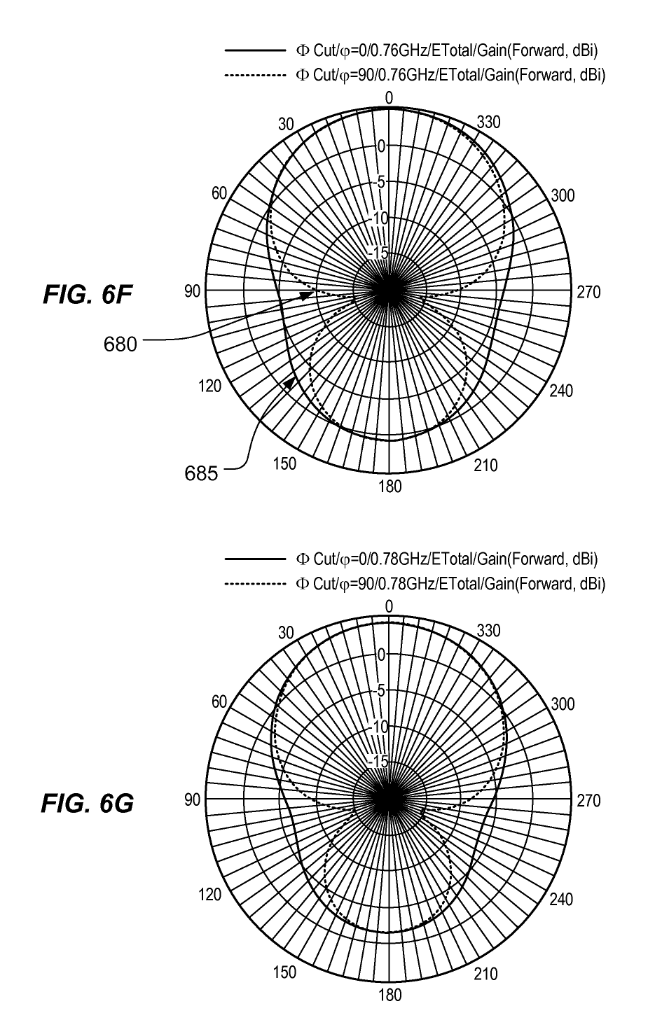

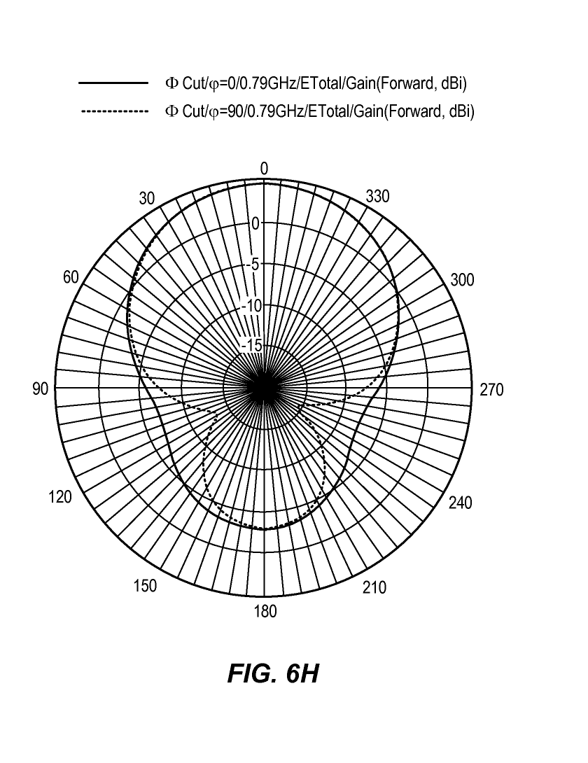

FIG. 6A through 6G depict simulated performance characteristics of the second antenna design. FIG. 6A is a plot of the simulated return loss, also called the reflection coefficient, of the second antenna design shown in FIG. 2 including the radome and PCBA over a range of frequencies. According to the plot in FIG. 6A, at point 610 the frequency is 783 MHz the return loss is −4.5 dB. At point 620 the frequency is 750 MHz and the return loss is −7.0 dB. The radiator 255 in Fig. is particularly effective around this frequency. At point 615 the frequency is 804 MHz and the return loss is −8.5 dB. For the frequency band from 720 to 806 MHz the return loss varies from −4.5 dB to −8.5 dB.

FIG. 6B is a Smith Chart of the simulated reflection coefficients for the second antenna without the radome and PCBA over a range of frequencies from 0.5 GHz to 1.0 GHz. The center of the chart at the point 640 labeled “1.0” represents a perfect impedance match between the first antenna design and a power source. At this point, all of the power from a power source connected to the antenna would be radiated by the antenna. Several dots 630 are placed along a circular line that has an inner loop 635 with each dot corresponding to a frequency at which the simulation was performed. The dot at the point labeled 634 is 750 MHz and corresponds to the frequency at point 620 in FIG. 6A, and the dot at the point labeled 636 is 804 MHz and corresponds to the frequency at point 615 in FIG. 4A. The distance from a dot to the center of the chart 640 is the value of its reflection coefficient. Hence, dots closer to the center of the chart have a lower reflection coefficient which, in turn, corresponds to a better impedance match between the first antenna and a power source at the corresponding frequency. Thus, those dots on the inner loop 625 on the chart represent a range of frequencies at which the second antenna best radiates.

FIG. 6C is a chart of the simulated gain for the second antenna design without the radome and PCBA. The maximum gain of 4.642 dB occurs at point 650 at a frequency of 760 MHz. The radiator 255 in FIG. 2 is particularly effective around this frequency. The gain remains consistently above 3 dB due to the design of the resonator cutouts 246, 266 in FIG. 2. For the frequency range 740 MHz to 800 MHz the gain is 2 dB or greater.

FIG. 6D is a chart of the simulated radiation efficiency of the second antenna design with the radome and PCBA. For the second antenna design, the simulated maximum radiation efficiency of 0.71 occurs at point 660 at a frequency of 750 MHz. The radiator 255 in FIG. 2 is particularly effective around this frequency. The small peak 665 at 790 MHz measures 0.61 to the design of the resonator cutouts 246, 266 in FIG. 2. For the frequency range 740 MHz to 800 MHz, the radiation efficiency is above 0.55.

FIG. 6E is a chart of the simulated directivity of the second antenna design without the radome and PCBA. The simulated maximum directivity of 6.752 dB occurs at point 670 at a frequency of 0.8 GHz. For the frequency range 0.74 GHz to 0.8 GHz, the directivity is above 5.5 dB.

FIGS. 6F, 6G and 6H are three charts of the simulated radiation patterns of the second antenna design with the radome and PCBA at three different frequencies. In FIG. 6F a first closed line 680 having two circular lobes is shown with the larger lobe facing 0 degrees. This line shows the radiation pattern from a fixed polar angle of 90 degrees and may be visualized as if viewed looking down on the antenna such that the antenna is oriented on edge with the Z axis (per the spherical coordinate system described above for FIGS. 4F, 4G, 4H) parallel to the longer side of the radiator 255 and vertically bisecting the radiator 255 shown in FIG. 2. Looking at the larger of the two lobes, called the forward or major lobe, it can be seen that this lobe exhibits a maximum gain which exceeds 0 dBi (dBi are decibels with respect to an ideal isotropic antenna).

In FIG. 6F, a second closed line 685 having no distinct lobes appears on this chart and shows the radiation pattern as viewed from a fixed polar angle of 0 degrees and may be visualized as if looking at the antenna orthogonal to the Z axis. In this case the larger end of the pattern shows that the first antenna design radiates more towards the top of the antenna in this simulation.

FIGS. 6G and 6H show the same information as described in FIG. 6F which is simulated at 760 MHz, with the only change being that the plot in FIG. 6G is simulated at 780 MHz and the plot in 6H is simulated at 790 MHz. It is apparent from these three charts (FIGS. 6F, 6G and 6H) that the simulated radiation pattern for the second antenna design is consistent across all three charts for the front lobe and that the rear lobe becomes smaller as the frequency increases.

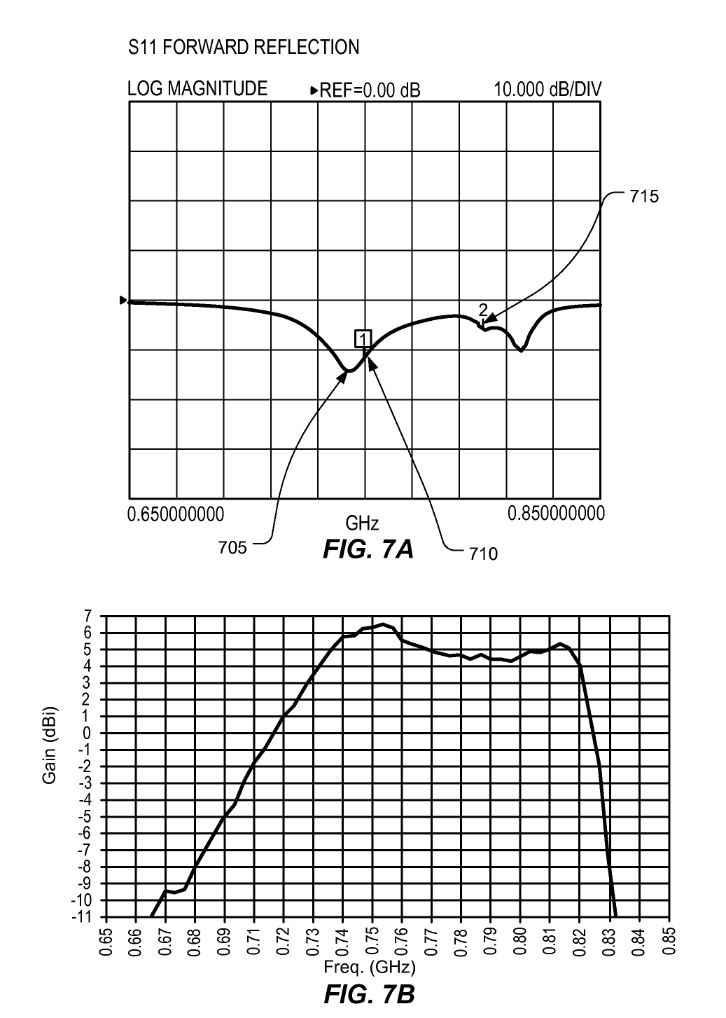

FIG. 7A through 7B depict measured performance characteristics of the second antenna design. FIG. 7A is a plot of the measured return loss for the second antenna design including the radome and the PCBA over the frequency range from 650 MHz to 850 MHz. At point 705 the frequency is 740 MHz and the measured return loss is −14 dB. At point 710 labeled “1’ on the chart, the frequency is 750 MHz and the measured return loss is −12 dB. At point 715 labeled “2’ on the chart, the frequency is 800 MHz and the measured return loss is −6 dB. For the frequency band from 740 to 800 MHz the return loss varies from −3 dB to −6 dB.

The antenna technology disclosed can be practiced in a variety of configurations. In one implementation, a patch antenna includes a rectangular ring radiator coplanar with two rectangular ring resonators on opposing sides of the rectangular ring radiator. It further includes a dielectric substrate underlying the rectangular rings; and a ground plane conductor material underlying the dielectric.

In this and other implementations, the patch antenna dielectric can include one or more of acrylonitrile butadiene styrene (abbreviated ABS), plastic, polypropylene, polyamide, Plexiglas or vinyl.

The chosen dielectric, for instance one of those listed above, can have a dielectric constant in the range of 2.5 to 3.5 or the range 2.0 to 4.5 or in one of the other ranges identified above.

The chosen dielectric, for instance one of those listed above or having a dielectric constant in a specified range, can have a dielectric substrate has a thickness in range of 15 mm+/−5 mm or a range of 12-30 mm.

In combination with any of the designs and/or characteristics above, the patch antenna can be described as having a first axis that bisects the rectangular rings. The rectangular ring radiator can be shorter along the first axis than it is wide, in an aspect ratio range of 1:1.33 to 1:1.39. The rectangular ring radiator alternatively can be in any of the aspect ratio ranges identified above; for instance, in an aspect ratio range of 1:1.89 to 1:1.97. The rectangular ring resonators are shorter along the first axis than they are wide, in a ratio range of 1:3.39 to 1:3.46. The rectangular ring resonators alternatively can be in any of the aspect ratio ranges identified above; for instance, in a ratio range of 1:3.39 to 1:3.4.

In combination with the designs and features above, the rectangular rings further include chamfers or rounding on some corners of said rings.

The patch antenna proportion of cutout areas, aspect ratios and/or dimensions can be effective in either a frequency range of 698 to 746 MHz or in a frequency range of 746 to 806 MHz. The proportion of area for cutout in radiator can be effective to broaden the bandwidth in a frequency range of 698 to 746 MHz. It can be effective to broaden the bandwidth in a frequency range of 746 to 806 MHz. The aspect ratios of radiator and resonators can be effective for gain in a frequency range of 698 to 746 MHz. It can be effective for gain in a frequency range of 746 to 806 MHz. The dimensions of radiator and resonators can be effective in a frequency range of 698 to 746 MHz. It can be effective in a frequency range of 746 to 806 MHz.

What is claimed is:

1. A patch antenna, comprising:
a rectangular ring radiator coplanar with two rectangular ring resonators on opposing sides of the rectangular ring radiator;
a dielectric substrate underlying the rectangular rings; and
a ground plane conductor material underlying the dielectric.

2. The patch antenna of claim 1, wherein the dielectric comprises acrylonitrile butadiene styrene (abbreviated ABS), plastic, polypropylene, polyamide, Plexiglas or vinyl.

3. The patch antenna of claim 1, wherein the dielectric comprises acrylonitrile butadiene styrene (abbreviated ABS).

4. The patch antenna of claim 1, wherein the dielectric substrate has a dielectric constant in the range of 2.0 to 4.5.

5. The patch antenna of claim 1, wherein the dielectric substrate has a dielectric constant in the range of 2.5 to 3.5.

6. The patch antenna of claim 1, wherein the dielectric substrate has a thickness in a range of 12-30 mm.

7. The patch antenna of claim 1, wherein the dielectric substrate has a thickness in a range of 15 mm+/−5 mm.

8. The patch antenna of claim 1, wherein:
a first axis bisects the rectangular rings;
the rectangular ring radiator is shorter along the first axis than it is wide, in an aspect ratio range of 1:1.33 to 1:1.39; and
the rectangular ring resonators are shorter along the first axis than they are wide, in a ratio range of 1:3.39 to 1:3.46.

9. The patch antenna of claim 1, wherein:
a first axis bisects the rectangular rings;
the rectangular ring radiator is shorter along the first axis than it is wide, in an aspect ratio range of 1:1.89 to 1:1.97; and
the rectangular ring resonators are shorter along the first axis than they are wide, in a ratio range of 1:3.39 to 1:3.46.

10. The patch antenna of claim 1, wherein rectangular rings further include modifications, such as chamfers or rounding on some corners of said rings

11. The patch antenna of claim 1, wherein proportion of area for cutout in radiator is effective to broaden the bandwidth in a frequency range of 698 to 746 MHz.

12. The patch antenna of claim 1, wherein proportion of area for cutout in radiator is effective to broaden the bandwidth in a frequency range of 746 to 806 MHz.

13. The patch antenna of claim 1, wherein aspect ratios of radiator and resonators are effective for gain in a frequency range of 698 to 746 MHz.

14. The patch antenna of claim 1, wherein aspect ratios of radiator and resonators are effective for gain in a frequency range of 746 to 806 MHz.

15. The patch antenna of claim 1, wherein dimensions of radiator and resonators are effective for gain in a frequency range of 698 to 746 MHz.

16. The patch antenna of claim 1, wherein dimensions of radiator and resonators are effective for gain in a frequency range of 746 to 806 MHz.
